(19) United States
(12) Patent Application Publication
(10) Pub. No.: US 2021/0126406 A1
(43) Pub. Date: Apr. 29, 2021

(54) BLUETOOTH ADAPTER HAVING ROTATABLE AUDIO PLUG

(71) Applicant: CHIEN-TANG HSIAO, Dongguan (CN)

(72) Inventor: CHIEN-TANG HSIAO, Dongguan (CN)

(21) Appl. No.: 17/035,745

(22) Filed: Sep. 29, 2020

(30) Foreign Application Priority Data
Oct. 29, 2019 (CN) 201921833113.4

(51) Int. Cl. H01R 13/66; H01R 13/44; H01R 24/58; H01R 13/70

(52) U.S. Cl. CPC H01R 13/6691; H01R 13/44; H04W 4/80; H01R 24/58; H01R 13/70; H01R 13/6675

(57) ABSTRACT

A Bluetooth adapter having rotatable audio plugs includes a housing, a control circuit board, and a power supply unit. The overall structure is compact and reasonable. The Bluetooth adapter is small in size and convenient to take along. When it is necessary to rotate the two audio plugs for use, the right sound channel of the stereo sound channels of the first audio plug can be switched off (that is, only the left sound channel), and the right sound channel of the second audio plug can be used to realize the stereo sound channels, suitable for two audio output ports provided on the seat of the airplane. The Bluetooth adapter is easy to use, has strong compatibility, and improves the overall sound effect.

### BACKGROUND OF THE INVENTION

### 1. Field of the Invention

The present invention relates to a Bluetooth adapter, and more particularly to a Bluetooth adapter having rotatable audio plugs with strong compatibility.

### 2. Description of the Prior Art

The seats of an airplane are equipped with earphones. In general, passengers can only use the earphones of the airplane. In fact, it is difficult for the earphones of the airplane to meet the needs of different passengers. Especially, people are increasingly pursuing personalization, product specialization, etc. Accordingly, the inventor of the present invention has devoted himself based on his many years of practical experiences to solve these problems and develop a Bluetooth adapter. People may use the Bluetooth adapter for transmission and personal Bluetooth earphones for reception instead of using the earphones of the airplane. In addition, the Bluetooth adapter also takes into account the product compatibility, portability, application flexibility, practicality, audio effects and other aspects.

### SUMMARY OF THE INVENTION

In view of the defects of the prior art, the primary object of the present invention is to provide a Bluetooth adapter having rotatable audio plugs with strong compatibility. The overall structure is compact and reasonable. The Bluetooth adapter is small in size and convenient to take along. When it is necessary to rotate the two audio plugs for use, the right sound channel of the stereo sound channels of the first audio plug can be switched off (that is, only the left sound channel), and the right sound channel of the second audio plug can be used to realize the stereo sound channels, suitable for two audio output ports provided on the seat of the airplane. The Bluetooth adapter is easy to use, has strong compatibility, and improves the overall sound effect.

In order to achieve the above object, the present invention adopts the following solutions.

A Bluetooth adapter comprises a housing, a control circuit board arranged in the housing, and a power supply unit for supplying power. The housing is provided with a power switch connected to the control circuit board. The housing is formed with a receiving cavity. The receiving cavity is provided with an elastic switch configured to switch off a sound channel and a first audio plug assembly and a second audio plug assembly that are rotatable relative to the housing.

The first audio plug assembly includes a first rotating seat and a first audio plug connected to the first rotating seat. The second audio plug assembly includes a second rotating seat and a second audio plug connected to the second rotating seat.

The elastic switch has a first contact terminal and a second contact terminal. The second contact terminal is connected to the first audio plug. The first contact terminal is connected to the control circuit board. The second rotating seat is selectively rotated to be in contact with or away from the first contact terminal. The second audio plug is connected to the control circuit board.

The first rotating seat and the second rotating seat are arranged side by side. Inner sides of the first rotating seat and the second rotating seat are axially pivoted to each other. Outer sides of the first rotating seat and the second rotating seat are pivotally connected to two opposite inner sides of the receiving cavity, respectively. The outer sides and the inner sides of the first rotating seat and the second rotating seat are coaxially pivoted.

When the Bluetooth adapter is not in use, the first audio plug and the second audio plug extend in a first direction, the second rotating seat is in contact with the first contact terminal, the elastic switch is compressed and deformed, and the first contact terminal and the second contact terminal are connected.

When the Bluetooth adapter is in a first use state, the first audio plug and the second audio plug extend in a second direction, the second direction and the first direction are arranged at an angle, the second rotating seat is rotated away from the first contact terminal, under a returning force of the elastic switch, the first contact terminal and the second contact terminal are disconnected.

When the Bluetooth adapter is in a second use state, the first audio plug extends in the second direction, the second audio plug extends in the first direction, the second direction and the first direction are arranged at an angle, the second rotating seat is in contact with the first contact terminal, the elastic switch is compressed and deformed, and the first contact terminal and the second contact terminal are connected.

Compared with the prior art, the present invention has obvious advantages and beneficial effects. Specifically, it can be seen from the above technical solutions, people may use the Bluetooth adapter for transmission and personal Bluetooth earphones for reception instead of using the earphones of the airplane. In particular, the overall structure is compact and reasonable. The Bluetooth adapter is small in size and convenient to take along. Through the elastic switch configured to switch off a sound channel, when only one audio plug is rotated for use, it can realize stereo sound channels and is suitable for a single audio output port on the airplane. When the two audio plugs are rotated for use, the right sound channel of the stereo sound channels of the first audio plug can be switched off (that is, only the left sound channel), and the right sound channel of the second audio plug can be used to realize the stereo sound channels, suitable for two audio output ports provided on the seat of the airplane. The Bluetooth adapter is easy to use, has strong compatibility, and improves the overall sound effect.

Secondly, the design of the arched portion ensures the stability and reliability of the connection between the first contact terminal and the second contact terminal.

### BRIEF DESCRIPTION OF THE DRAWINGS

FIG. 1 is a perspective view according to a first embodiment of the present invention;

FIG. 2 is another perspective view according to the first embodiment of the present invention;

FIG. 3 is an exploded view according to the first embodiment of the present invention;

FIG. 4 is a schematic view according to the first embodiment of the present invention in a first use state;

FIG. 5 is a schematic view according to the first embodiment of the present invention in a second use state;

FIG. 6 is a top view of FIG. 5;

FIG. 7 is a schematic view showing part of the elastic switch according to the first embodiment of the present invention;

FIG. 8 is a schematic circuit diagram according to the first embodiment of the present invention;

FIG. 9 is another schematic circuit diagram according to the first embodiment of the present invention;

FIG. 10 is a schematic view according to a second embodiment of the present invention when in use; and

FIG. 11 is a schematic view of the elastic switch according to the second embodiment of the present invention.

### DETAILED DESCRIPTION OF THE PREFERRED EMBODIMENTS

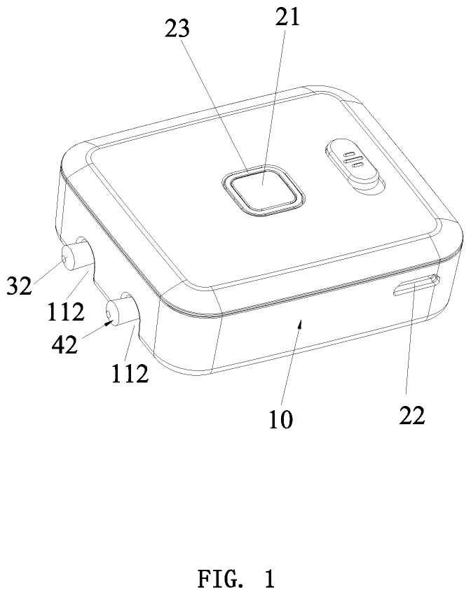

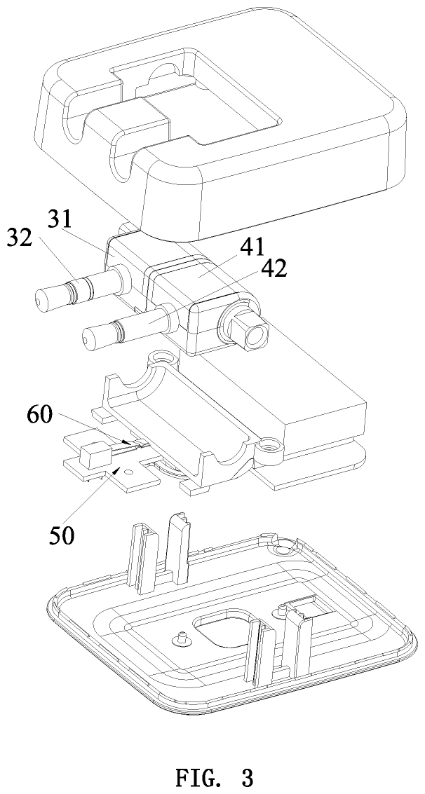

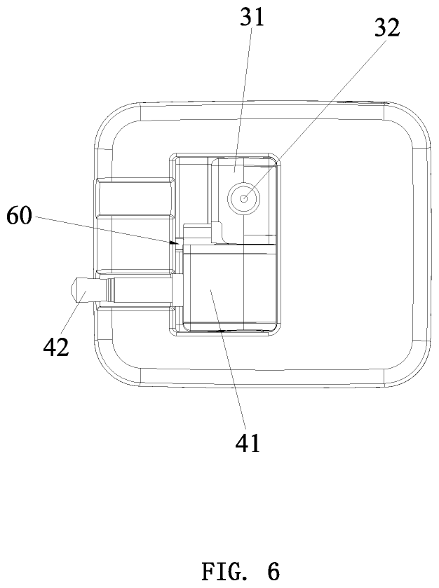

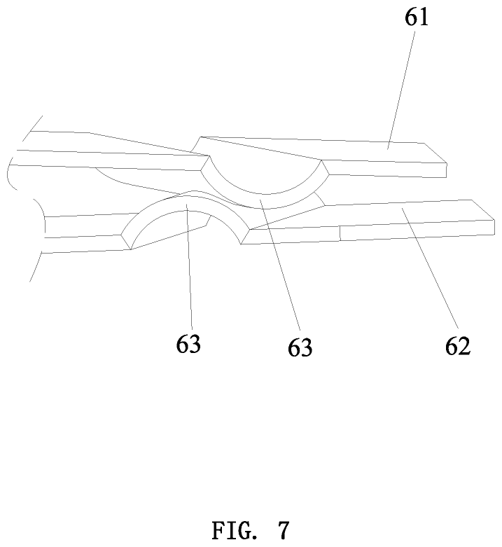

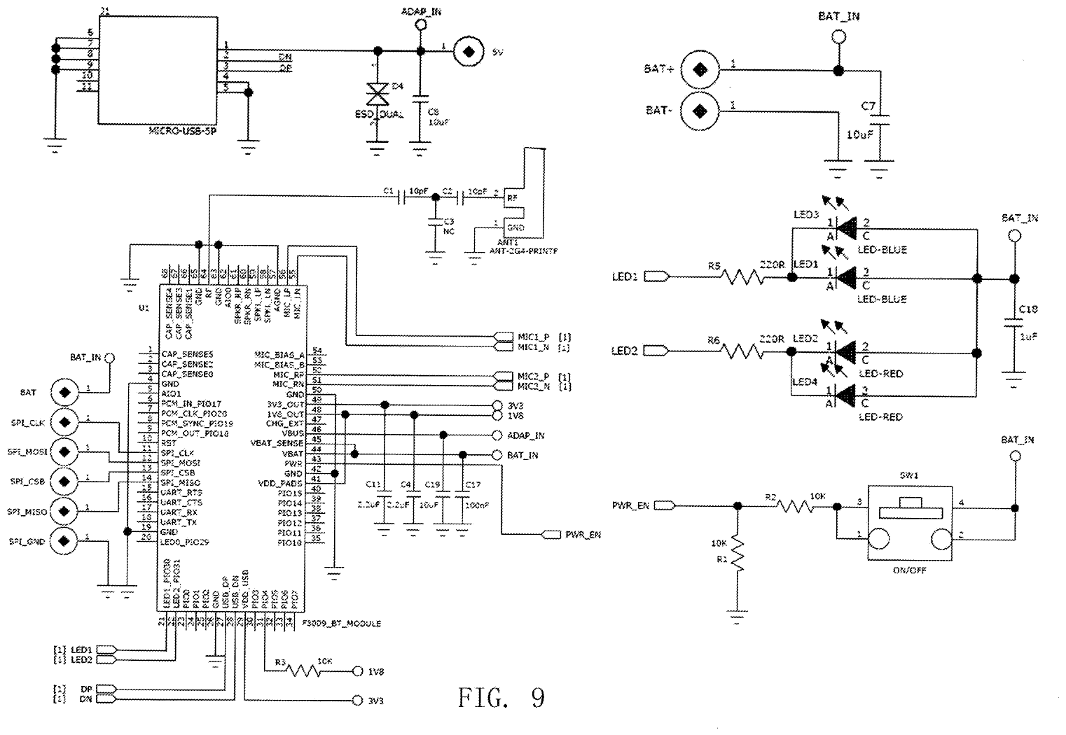

FIGS. 1 to 9 show the specific structure of a first embodiment of the present invention.

A Bluetooth adapter having rotatable audio plugs with strong compatibility comprises a housing 10, a control circuit board 50 arranged in the housing 10, and a power supply unit for supplying power. The housing 10 is provided with a power switch 21 connected to the control circuit board 50. The housing 10 is provided with a USB charge port 22 for charging the power supply unit. Generally, the power switch 21 is disposed at the central portion of the top of the housing 10, and the central button design is easy for operation. An annular LED indicator 23 is provided on the periphery of the power switch 21, and its indication function is obvious and easy to understand. The Bluetooth adapter can be connected with more than one Bluetooth device. In general, the Bluetooth adapter is used to connect with one Bluetooth device or two Bluetooth devices simultaneously.

The housing 10 is formed with a receiving cavity 11. The receiving cavity 11 is provided with an elastic switch 60 configured to switch off a sound channel and a first audio plug assembly and a second audio plug assembly that are rotatable relative to the housing 10.

The first audio plug assembly includes a first rotating seat 31 and a first audio plug 32 connected to the first rotating seat 31. The second audio plug assembly includes a second rotating seat 41 and a second audio plug 42 connected to the second rotating seat 41.

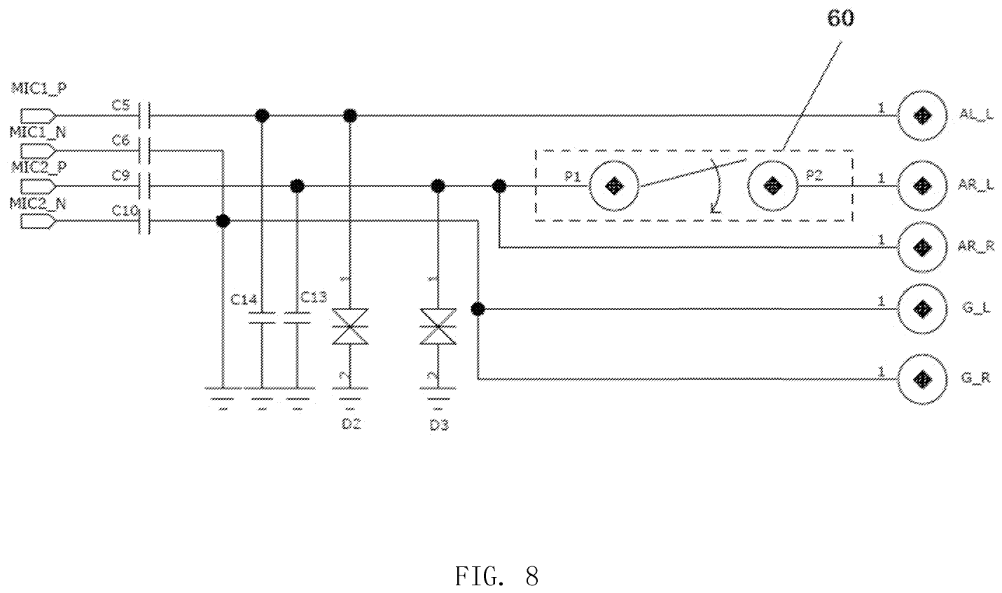

The elastic switch 60 has a first contact terminal 61 (in particular, the first contact terminal is P1 in FIG. 8) and a second contact terminal 62 (in particular, the second contact terminal is P2 in FIG. 8). The second contact terminal 62 is connected to the first audio plug 32. The first contact terminal 61 is connected to the control circuit board 50. The second rotating seat 41 is selectively rotated to be in contact with or away from the first contact terminal 61. The second audio plug 42 is connected to the control circuit board 50.

In this embodiment, the control circuit board 50 includes a main control circuit and an audio input circuit, a Bluetooth communication circuit and an LED drive circuit that are connected to the main control circuit, respectively. The main control circuit outputs audio signals to peripherals (such as Bluetooth headsets) through the Bluetooth communication circuit. The LED drive circuit is configured to drive the annular LED indicator 23.

The main control circuit includes a main control chip U1. The main control chip U1 has main control pins 1 to 68. The audio input circuit includes a capacitor C5, a capacitor C6, a capacitor C9, a capacitor C10, a capacitor C13, a capacitor C14, a field effect transistor D2 and a field effect transistor D3. The first audio plug 32 has an AL_L contact, an AR_L contact, and a G_L contact. The second audio plug 42 has an AR_R contact and a G_R contact.

The main control pin 56 is connected to the AL_L contact through the capacitor C5. The AL_L contact is grounded through the field effect transistor D2 and grounded through the capacitor C14. The AR_L contact is connected to the second contact terminal 62. The main control pin 52 is connected to the first contact terminal 61 through the capacitor C9. The first contact terminal 61 is grounded through the field effect transistor D3 and grounded through the capacitor C13. The AR_R contact is connected to the first contact terminal 61.

Both the G_L contact and the G_R contact are grounded. The main control pin 55 is grounded through the capacitor C6. The main control pin 51 is grounded through the capacitor C10.

Preferably, the first contact terminal 61 and the second contact terminal 62 are arranged symmetrically. The opposite sides of the first contact terminal 61 and/or the second contact terminal 62 are convexly provided with arched portions 63 facing each other. The arched portion 63 of the first contact terminal 61 and the arched portion 63 of the second contact terminal 62 are staggered to form an X-like shape. Of course, they may be staggered to form a cross shape, but not limited thereto.

The first rotating seat 31 and the second rotating seat 41 are arranged side by side. The inner sides of the first rotating seat 31 and the second rotating seat 41 are axially pivoted to each other. The outer sides of the first rotating seat 31 and the second rotating seat 41 are pivotally connected to two opposite inner sides of the receiving cavity 11, respectively. The outer sides and the inner sides of the first rotating seat 31 and the second rotating seat 41 are coaxially pivoted.

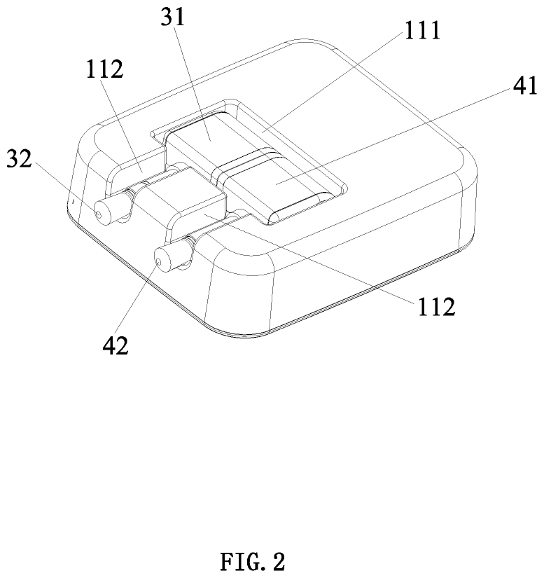

As shown in FIG. 2, when the Bluetooth adapter is not in use, the first audio plug 32 and the second audio plug 42 extend in a first direction, the second rotating seat 42 is in contact with the first contact terminal 61, the elastic switch 60 is compressed and deformed, and the first contact terminal 61 and the second contact terminal 62 are connected.

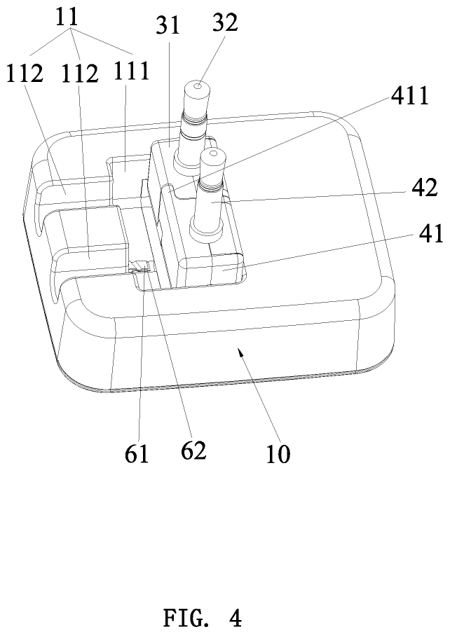

As shown in FIG. 4, when the Bluetooth adapter is in a first use state, the first audio plug 32 and the second audio plug 42 extend in a second direction. The second direction and the first direction are arranged at an angle. The second rotating seat 41 is rotated away from the first contact terminal 61. Under the returning force of the elastic switch 60, the first contact terminal 61 and the second contact terminal 62 are disconnected. The AR_L contact of the first audio plug 32 is disconnected from the main control circuit. The AL_L contact of the first audio plug 32 is still connected with the main control circuit to form a left sound channel. At the same time, the AL_L contact of the second audio plug 42 is connected to the main control circuit to form a right sound channel. The left sound channel of the first audio plug 32 cooperates with the right sound channel of the second audio plug 42 to achieve stereo sound, which has better compatibility. This can overcome the problem that when the two conventional audio plugs are plugged in a use state, the sound channel of one of the audio plugs is shielded, which affects the overall sound quality.

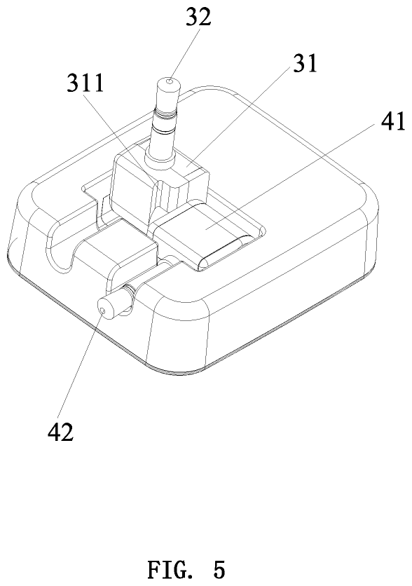

As shown in FIG. 5, when the Bluetooth adapter is in a second use state, the first audio plug 32 extends in the second direction, and the second audio plug 42 extends in the first direction. The second direction and the first direction are arranged at an angle. Preferably, the second direction is perpendicular to the first direction. The second rotating seat 41 is in contact with the first contact terminal 61. The elastic switch 60 is compressed and deformed. The first contact terminal 61 and the second contact terminal 62 are connected, so that the AR_L contact of the first audio plug 32 is connected with the main control circuit. At the same time, the AL_L contact of the first audio plug 32 is still connected with the main control circuit. Therefore, when the second audio plug 42 is not in use, the first audio plug 32 has a left sound channel and a right sound channel at the same time, that is, a single audio plug realizes stereo sound channels.

The receiving cavity 11 includes a first receiving cavity 111 for the first rotating seat 31 and the second rotating seat 32 to be rotated therein and two second receiving cavities 112 for receiving the first audio plug 32 and the second audio plug 42 respectively. The first receiving cavity 111 has a bottom opening on the housing 10. The first receiving cavity 111 communicates with one end of each of the two second receiving cavities 112. The other end of each of the two second receiving cavities 112 is formed with a side opening on the housing 10. The power switch 21 is arranged on the top of the housing 10. Extending in the first direction refers to extending from the inside of the second receiving cavity 112 toward the side opening. Extending in the second direction refers to extending from the inside of the first receiving cavity 111 toward the bottom opening.

Therefore, the two independently rotatable audio plugs can be flexibly applied to a single audio output port or two audio output ports on the seat of an airplane, and its application range is wide. In this embodiment, as shown in FIG. 2 to FIG. 5, the top of the first rotating seat 31 is formed with a notch 311 extending downward, and the second rotating seat 41 has a pushing portion 411 extending into the notch 311. In this way, the first rotating seat 31 can be individually rotated upward and downward, and the first rotating seat 31 can be pushed by the second rotating seat 41 to rotate downward. The second rotating seat 41 can be individually rotated upward and downward, and the second rotating seat 41 can be pushed by the first rotating seat 31 to rotate upward. In actual operation, if the seat of the airplane is equipped with only a single audio output port, the first rotating seat 31 is directly rotated downward so that the first audio plug 32 protrudes from the bottom of the housing 10 for plugging. The first audio plug 32 can realize stereo sound channels. If the seat of the airplane is equipped with two audio output ports, the second rotating seat 41 is directly rotated downward. (The first rotating seat 31 is pushed by the pushing portion 411 to synchronously rotate downward. The first audio plug 32 realizes the left sound channel. The second audio plug 42 realizes the right sound channel. The two cooperate to realize stereo sound channels.) When not in use, the Bluetooth adapter is unplugged and the first rotating seat 31 is directly rotated upward. It is very convenient and simple for operation.

An audio female socket may be provided on the housing 10. The control circuit board 50 is provided with an audio output unit, and the audio output unit is connected to the audio female socket. In this way, passengers can choose ordinary headsets with wires instead of Bluetooth headsets.

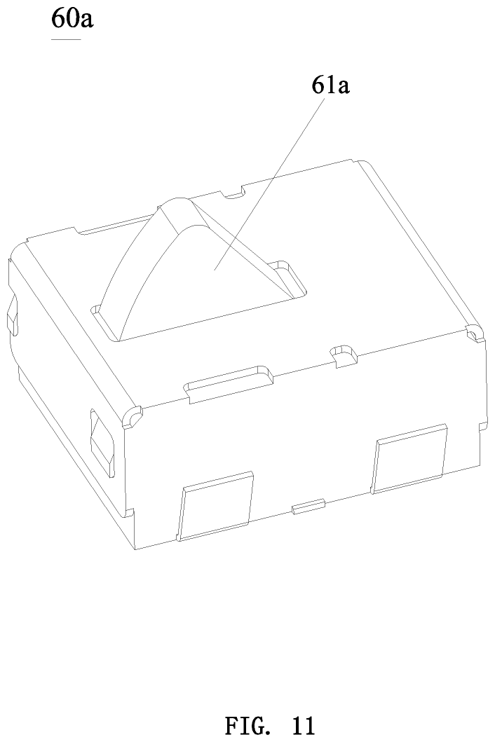

In a second embodiment, as shown in FIG. 11, the elastic switch 60a is a touch switch. Preferably, the touch switch may adopt a small two-way detector switch (manufactured by Alps Electric Co. Ltd., SPVM series, Model No. SPVM110100). It can be triggered vertically and horizontally, and its welding is easy, so the welding efficiency is improved.

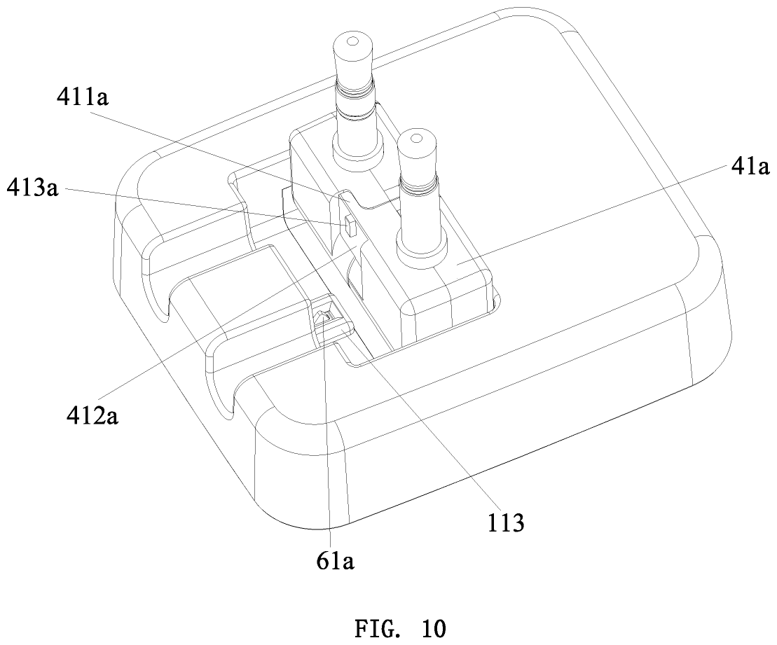

As shown in FIG. 10, the inner top wall of the first receiving cavity 111a is protruded downwardly with an annular raised portion 113 surrounding the periphery of the elastic switch 60a. The first contact terminal 61a extends out of the annular raised portion 113. The annular raised portion 113 is configured to protect the elastic switch 60a.

The end face of the pushing portion 411a, facing the first direction, is provided with a trigger protrusion 413a. The trigger protrusion 413a is selectively moved to be in contact with or away from the first contact terminal 61a along with rotation of the second rotating seat 41a. Preferably, the end surface of the pushing portion 411a, facing the first direction, is formed with a recess 412a. The trigger protrusion 413a protrudes from the inner wall of the recess 412a. It should be noted that the second embodiment is substantially similar to the first embodiment except the structure of the elastic switch, the annular raised portion, the recess and the trigger protrusion.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A Bluetooth adapter, comprising a housing, a control circuit board disposed in the housing, and a power supply unit for supplying power; the housing being provided with a power switch connected to the control circuit board; the housing being formed with a receiving cavity, the receiving cavity being provided with an elastic switch configured to switch off a sound channel and a first audio plug assembly and a second audio plug assembly that are rotatable relative to the housing;
the first audio plug assembly including a first rotating seat and a first audio plug connected to the first rotating seat, the second audio plug assembly including a second rotating seat and a second audio plug connected to the second rotating seat;
the elastic switch having a first contact terminal and a second contact terminal, the second contact terminal being connected to the first audio plug, the first contact terminal being connected to the control circuit board, the second rotating seat being selectively rotated to be in contact with or away from the first contact terminal; the second audio plug being connected to the control circuit board;
the first rotating seat and the second rotating seat being arranged side by side, inner sides of the first rotating seat and the second rotating seat being axially pivoted to each other, outer sides of the first rotating seat and the second rotating seat being pivotally connected to two opposite inner sides of the receiving cavity, respectively; the outer sides and the inner sides of the first rotating seat and the second rotating seat being coaxially pivoted;
wherein when the Bluetooth adapter is not in use, the first audio plug and the second audio plug extend in a first direction, the second rotating seat is in contact with the first contact terminal, the elastic switch is compressed and deformed, and the first contact terminal and the second contact terminal are connected;
wherein when the Bluetooth adapter is in a first use state, the first audio plug and the second audio plug extend in a second direction, the second direction and the first direction are arranged at an angle, the second rotating seat is rotated away from the first contact terminal, under a returning force of the elastic switch, the first contact terminal and the second contact terminal are disconnected;
wherein when the Bluetooth adapter is in a second use state, the first audio plug extends in the second direction, the second audio plug extends in the first direction, the second direction and the first direction are arranged at an angle, the second rotating seat is in contact with the first contact terminal, the elastic switch is compressed and deformed, and the first contact terminal and the second contact terminal are connected.

2. The Bluetooth adapter as claimed in claim 1, wherein the control circuit board includes a main control circuit and an audio input circuit;
the main control circuit includes a main control chip U1, the main control chip U1 has main control pins 1 to 68, the audio input circuit includes a capacitor C5, a capacitor C6, a capacitor C9, a capacitor C10, a capacitor C13, a capacitor C14, a field effect transistor D2 and a field effect transistor D3, the first audio plug has an AL_L contact, an AR_L contact and a G_L contact, the second audio plug has an AR_R contact and a G_R contact;
the main control pin 56 is connected to the AL_L contact through the capacitor C5, the AL_L contact is grounded through the field effect transistor D2 and grounded through the capacitor C14, the AR_L contact is connected to the second contact terminal, the main control pin 52 is connected to the first contact terminal through the capacitor C9, the first contact terminal is grounded through the field effect transistor D3 and grounded through the capacitor C13, the AR_R contact is connected to the first contact terminal;
the G_L contact and the G_R contact are grounded, the main control pin 55 is grounded through the capacitor C6, and the main control pin 51 is grounded through the capacitor C10.

3. The Bluetooth adapter as claimed in claim 1, wherein the first contact terminal and the second contact terminal are arranged symmetrically.

4. The Bluetooth adapter as claimed in claim 3, wherein opposite sides of the first contact terminal and/or the second contact terminal are convexly provided with arched portions facing each other.

5. The Bluetooth adapter as claimed in claim 4, wherein the arched portion of the first contact terminal and the arched portion of the second contact terminal are staggered to form an X-like shape.

6. The Bluetooth adapter as claimed in claim 1, wherein the receiving cavity includes a first receiving cavity for receiving the first rotating seat and the second rotating seat therein and two second receiving cavities for receiving the first audio plug and the second audio plug therein, the first receiving cavity has a bottom opening on the housing, the first receiving cavity communicates with one end of each of the two second receiving cavities, another end of each of the two second receiving cavities is formed with a side opening on the housing, the power switch is arranged on a top of the housing; extending in the first direction refers to extending from an inside of the second receiving cavity toward the side opening, and extending in the second direction refers to extending from an inside of the first receiving cavity toward the bottom opening.

7. The Bluetooth adapter as claimed in claim 6, wherein an inner top wall of the first receiving cavity is protruded downwardly with an annular raised portion surrounding a periphery of the elastic switch, and the first contact terminal extends out of the annular raised portion.

8. The Bluetooth adapter as claimed in claim 1, wherein a top of the first rotating seat is formed with a notch extending downward, the second rotating seat has a pushing portion extending into the notch; the first rotating seat is individually rotatable upward and downward, the first rotating seat is pushed by the second rotating seat to rotate downward; the second rotating seat is individually rotatable upward and downward, and the second rotating seat is pushed by the first rotating seat to rotate upward.

9. The Bluetooth adapter as claimed in claim 8, wherein an end face of the pushing portion, facing the first direction, is provided with a trigger protrusion, and the trigger protrusion is selectively moved to be in contact with or away from the first contact terminal along with rotation of the second rotating seat.

10. The Bluetooth adapter as claimed in claim 9, wherein the end surface of the pushing portion, facing the first direction, is formed with a recess, and the trigger protrusion protrudes from an inner wall of the recess.
